(19) United States
(12) Patent Application Publication
(10) Pub. No.: US 2015/0101082 A1
(43) Pub. Date: Apr. 9, 2015

(54) PROCESSING SEEDS BY COLD PLASMA TREATMENT TO REDUCE AN APPARENT CONTACT ANGLE OF SEEDS COAT SURFACE

(71) Applicant: ARIEL-UNIVERSITY RESEARCH AND DEVELOPMENT COMPANY, LTD., Ariel (IL)

(72) Inventors: Edward Bormashenko, Ariel (IL); Roman Grynyov, Ariel (IL); Yelena Bormashenko, Ariel (IL); Elyashiv Drobi, Shilo (IL)

(21) Appl. No.: 14/396,484

(22) PCT Filed: Apr. 23, 2013
(86) PCT No.: PCT/IB2013/053213

§ 371 Date: Oct. 23, 2014

Related U.S. Application Data
(60) Provisional application No. 61/636,752, filed on Apr. 23, 2012.

(51) Int. Cl. A01C 1/00

(52) U.S. Cl. CPC A01C 1/00
USPC 800/298; 47/57.6

(57) ABSTRACT

Disclosed are methods for reduction on apparent contact angle of seeds coat surface by cold plasma treatment, agricultural devices for said treatment and seeds obtained by methods thereof.

### RELATED APPLICATION

The present application gains priority from U.S. Provisional Patent Application No. 61/636,752 filed 23 Apr. 2012, which is included by reference as if fully set-forth herein.

### FIELD AND BACKGROUND OF THE INVENTION

The invention, in some embodiments, relates to the field of agriculture and food science, and more particularly to methods for processing seeds that, in some embodiments, increase the utility thereof.

There is often a need to germinate seeds.

In the field of agriculture, seeds are sown in a growth medium, typically an open field, a greenhouse or a vessel containing soil (geoponics) or a water/nutrient mix with or without an inert support medium (hydroponics and aeroponics). When water in the growth medium contacts the seeds, germination starts and the seeds eventually sprout forming seedlings. The percentage of the sown seeds that germinate is the germination rate. The germination rate is usually less than 100%, meaning that an excess of seeds must be sown to provide a desired yield of plants.

In the field of edible products and the culinary arts, seeds are germinated and then used for the production of various food stuffs and edible additives including malted grain (e.g., for preparing beer, whiskey, malted vinegar), wheatgrass, breads such as Essene bread or edible sprouts (e.g., of pulses, cereals, oils seeds, brassica, umbelliferous vegetables, allium and other vegetables and herbs). Unsprouted seeds (due to less than 100% germination rate) are wasted and may lead to fungal growth or an inferior final product.

In the field of the culinary arts, dry seeds are often rehydrated before use, especially but not exclusively, legumes such as beans, lentils, peas and chickpeas. Rehydration is relatively slow and requires the use of excess water. Although not necessarily a significant issue in small-scale (home) cooking, in industrial settings the time and water required for rehydration may constitute a significant cost in the preparation of a food based on rehydrated seeds.

Volin J C, Denes F S, Young R A, Park S M T “Modification of seed germination performance through cold plasma chemistry technology”, Crop. Sci. 2000, 40, 1706-1718 disclose treatment of radish, pea, corn, soybean and bean with cold radiofrequency plasma to modify seed properties, the plasma generated by a 1000 W 13.56 MHz radiofrequency field in an atmosphere of various gases.

Volin et al report that plasma treatment in a CF₄ atmosphere led to formation of a layer on radish and pea seeds that resulted in a significant delay of germination compared to non-treated seeds. Plasma treatment in an octadecafluorodecalin atmosphere led to formation of a layer on soybean, corn and pea that resulted in a significant delay of germination compared to non-treated seeds.

Volin et al also report that plasma treatment for 5 minutes in a 150 mT (9.4 or 20 Pa) cyclohexane atmosphere of soybean (but not corn) led to accelerated germination. Plasma treatment for 20 minutes in a 200 mT (27 Pa) hydrazine atmosphere of corn led to accelerated germination. Plasma treatment for 20 minutes in a 200 mT (27 Pa) aniline atmosphere of corn and soybean led to accelerated germination.

Cyclohexane (C₆H₁₂, MW=84) is extremely flammable (flash point −20° C.), narcotic by inhalation and may cause skin irritation.

Hydrazine (N₂NH₄, MW=32) is highly reactive, highly toxic (LD50 ˜60 mg/kg oral in rats and mice), flammable and unstable (autoignition at 24 to 270° C., flash point 52° C., explosive at 1.8%) and corrosive.

Aniline (C₆H₅NH₂, MW=93) is offensive-smelling, flammable (flash point 70° C.), is toxic by inhalation (LC50 175 ppm 7 hours mice) and is expected to be very toxic to terrestrial and aquatic life when released in the environment (EC50/48-hours <1 mg/1 daphnia).

### SUMMARY OF THE INVENTION

The invention, in some embodiments, relates to methods for processing seeds that, in some embodiments, increase the utility of the seeds, as well as seeds processed using the method.

According to an aspect of some embodiments of the invention, there is provided a method of treating plant seeds comprising:
providing a plant seed having a seed coat with an outer surface having a natural apparent contact angle; and
exposing the plant seed to a plasma under conditions effective to substantially reduce the apparent contact angle of the seed coat surface from the natural apparent contact angle to a treated apparent contact angle.

In some embodiments, the apparent contact angle of the seed coat surface is reduced by not less than about 10°, so that the treated apparent contact angle is not less than about 10° lower than the natural contact angle.

In some embodiments, the exposing of the plant seed to the plasma is such that the treated apparent contact angle is less than 90° (hydrophilic). In some such embodiments, the natural apparent contact angle is greater than 90° (hydrophobic), so that an initially hydrophobic seed coat surface becomes hydrophilic.

In some embodiments, the plasma comprises a cold radiofrequency plasma. In some such embodiments, the plasma is generated by a radiofrequency field having a frequency of not less than about 100 kHz and even not less than about 1 MHz. In some such embodiments, the plasma is generated by a radiofrequency field having a frequency of not more than about 100 MHz.

In some embodiments, the seed is exposed to the plasma for not less than about 1 second. In some embodiments, the seed is exposed to the plasma for not more than about 60 minutes. In some embodiments, the seed is exposed to the plasma for not more than about 4 minutes. In some embodiments, the seed is exposed to the plasma for not more than about 1 minute.

In some embodiments, the seed is exposed to the plasma in a chamber including an atmosphere from which the plasma is generated.

In some embodiments, the pressure of the atmosphere in the chamber is not more than about 500 Pa. In some embodiments, the pressure of the atmosphere in the chamber is not more than about 10 Pa.

In some embodiments, the weight percent of organic carbon in the atmosphere is not more than about 70%.

In some embodiments, the atmosphere comprises a gas selected from the group of gases consisting of air, oxygen, nitrogen, argon and neon and mixtures thereof.

In some embodiments, the method further comprises: subsequent to the exposure to plasma, contacting the seed with water.

In some such embodiments, the contacting with water is under conditions allowing the seed to germinate.

In some embodiments, the method further comprises: planting the seed.

In some embodiments, the method further comprises: subsequent to the exposure to plasma, waiting a period of time during which the plant seed sprouts; and subsequently preparing a foodstuff from the sprouted seed.

In some embodiments, the method further comprises: subsequent to the exposure to plasma, contacting the plant seed with water for rehydration of the seed; and subsequently preparing a foodstuff from the rehydrated seed.

According to an aspect of some embodiments of the invention, there is also provided a location comprising: a plasma-generating device, the plasma-generating device configured for treating plant seeds according to an embodiment of the method according to the teachings herein; wherein the location is selected from the group consisting of a kitchen (preferably a commercial kitchen), a food-manufacturing location (preferably an industrial food- manufacturing location) and a plant-growing location (preferably an industrial plant-growing location).

According to an aspect of some embodiments of the invention, there is also provided an agricultural device comprising:

a plasma-generating device suitable for treating plant seeds in accordance with an embodiment of the method according to the teachings herein; and

functionally associated with the plasma-generating device, a sowing-component, configured to plant seeds accepted from the plasma-generating device subsequent to the treatment.

According to an aspect of some embodiments of the invention, there is also provided a viable plant seed of a type of plant, comprising a seed coat, wherein the apparent contact angle of the surface of the seed coat is substantially lower than the natural apparent contact angle of the surface of a seed coat of the type of plant, wherein the plant seed is an ungerminated viable plant seed.

In some embodiments, the apparent contact angle of the seed coat surface is not less than about 10° lower than the natural apparent contact angle of a seed coat surface of the type of plant.

In some embodiments, the seed coat surface is hydrophilic, having an apparent contact angle of less than 90°. In some such embodiments, the plant seed is of a type of plant with a naturally hydrophobic seed coat surface having a natural apparent contact angle of greater than 90°.

Unless otherwise defined, all technical and scientific terms used herein have the same meaning as commonly understood by one of ordinary skill in the art to which the invention pertains. In case of conflict, the specification, including definitions, will take precedence.

As used herein, the terms “comprising”, “including”, “having” and grammatical variants thereof are to be taken as specifying the stated features, integers, steps or components but do not preclude the addition of one or more additional features, integers, steps, components or groups thereof.

As used herein, the indefinite articles “a” and “an” mean “at least one” or “one or more” unless the context clearly dictates otherwise.

As used herein, when a numerical value is preceded by the term “about”, the term “about” is intended to indicate +/−10%.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

In the Figures:

FIG. 1 is a schematic depiction of the inductively-coupled plasma device used to treat seeds with plasma as described herein;

FIG. 2A is a reproduction of a SEM image (10000×) of an untreated lentil seed;

FIG. 2B is a reproduction of a SEM image (5000×) of an untreated bean seed;

FIG. 2C is a reproduction of a SEM image (10000×) of an untreated wheat seed;

FIGS. 3A-3B are reproductions of images of a water droplet on the sead coat surface of an untreated lentil (FIG. 3A) and a treated lentil (FIG. 3B);

FIGS. 4A-4D are reproductions of images of a water droplet on the seed coat surface of an untreated lentil held at different angles, demonstrating the “rose petal” effect;

FIGS. 5A-5B are reproductions of images of a water droplet on the seed coat surface of an untreated bean (FIG. 5A) and a treated bean (FIG. 5B);

FIGS. 6A-6B are reproductions of images of a water droplet on the seed coat surface of an untreated wheat seed (FIG. 6A) and a treated wheat seed (FIG. 6B);

FIGS. 7A-7C are graphs comparing water absorption as a function of time of treated and untreated beans (FIG. 7A), treated and untreated lentils (FIG. 7B) and treated and untreated wheat seeds (FIG. 7C); and

FIGS. 8A-8C are graphs comparing germination of treated and untreated beans (FIG. 8A), treated and untreated lentils (FIG. 8B) and treated and untreated wheat seeds (FIG. 8C).

### DESCRIPTION OF SOME EMBODIMENTS OF THE INVENTION

The invention, in some embodiments, relates to methods for processing seeds that, in some embodiments, increase the utility of the seeds, seeds processed using the method and devices and locations useful for implementing the method.

As discussed in the introduction, the germination rate of a given type of seed is typically significantly less than 100%, meaning that an excess of seeds must be sown or used to achieve a desired effect or product. In some instances, a large amount of water and/or long time is required to hydrate seeds, in some instances, to initiate germination. In some instances, the presence of non-germinated seeds may negatively affect the quality of a product.

Treating Plant Seeds with Plasma

According to an aspect of some embodiments of the teachings herein, there is provided a method of treating plant seeds, comprising:
providing a plant seed (preferably an ungerminated, viable plant seed) having a seed coat (preferably an intact seed coat) having a natural apparent contact angle; and
exposing the plant seed to a plasma (an ionized gas) under conditions effective to substantially reduce the apparent contact angle of the seed coat surface from the natural apparent contact angle to a treated apparent contact angle (increasing the wettability by water of the seed coat surface).

As used herein, by the term “viable plant seed” is meant a plant seed that under proper conditions germinates. As discussed in greater detail hereinbelow, in some embodiments, exposing the plant seeds to the plasma increases the germination rate of the plant seed.

In some embodiments, the apparent contact angle of the seed coat surface is reduced by not less than about 10°, not less than about 20°, not less than about 30° and even not less than about 40°. In some embodiments, the reduction of apparent contact angle of the seed coat surface is such that a hydrophobic seed coat surface (having a natural apparent contact angle greater than)90° becomes hydrophilic (having an apparent contact angle less than)90°.

In some embodiments, the plant seed is treated to neutralize pathogens prior to the exposure to the plasma. In some embodiments, the plant seeds are treated to neutralize pathogens subsequent to the exposure to the plasma. In some embodiments, the plant seeds are used without such treatment to neutralize pathogens.

The teachings herein are applicable to any suitable seed type of plant, including vegetable seeds, grass seeds, oil seeds and grain seeds. That said, in some embodiments the seed is of legumes (Fabaceae) such as alfalfa, carobs, chickpea (Cicer arietinum), clovers, fenugreek, lupins, mung beans, peas (Pisum sativum), soybeans (Glycine max) and vetches, but especially seeds of the genus Phaseolus, vigna and lentils (Lens culinaris). In some embodiments the seed is Poaceae, such as Panicoideae such as maize, sorghum, sugarcane, millet; Ehrhartoideae such as rice; Avena such as oats; and Pooideae such as lawn grass, pasture grass and Triticeae, such as Hordeum (barley), Secale (rye) and especially Triticum (wheat, including kamut). Other suitable types of seeds include oil seeds (almond, hazelnut, linseed, peanut, sesame, sunflower), Brassica (arugula, broccoli, cabbage, daikon, mizuna, mustard, radish, tatsoi, turnip, watercress), umbelliferous vegetables (carrot, celery, fennel, parsley), allium (garlic, green onion, leek, onion), solanaceae (tomato, potato, paprika, aubergine or eggplant) and other edible plants such as amaranth, buckwheat, lettuce, maize, milk thistle, quinoa, rhubarb and spinach.

It has been found that exposure of plant seeds to plasma according to the teachings herein has one or more unexpected advantages.

In some embodiments, exposure of seeds to plasma according to the teachings herein eases rehydration of seeds, allows reduction of the amount of water used and time required for rehydrating seeds, for example in the field of industrial and culinary food-preparation. Without wishing to be held to any one theory, the Inventors currently believe that this effect is possibly attributable to the reduction of apparent contact angle of the surface of the seed coat.

In some embodiments, exposure of a seed to plasma according to the teachings herein increases the germination rate of the seed, that is to say, increases the chance that a given thus-exposed seed will subsequently germinate in suitable conditions, both for agricultural uses (e.g., planting) and for culinary uses (e.g., for malting, production of food stuff such as edible sprouts or Essene bread), with the concomitant advantages that such increased germination rate provides.

In some embodiments, exposure of a seed to plasma according to the teachings herein provides a quicker onset of germination and shorter “time window” during which a batch of treated seeds germinate. In some embodiments, such improved control is advantageous in agriculture, in the culinary arts, or in the food industry.

In some embodiments, exposure of a seed to plasma according to the teachings herein allows reduction of the amount of water used for germinating seeds, in some embodiments for agricultural purposes and in some embodiments for culinary or food industry uses.

These advantages are especially surprising in light of the teachings of Selcuk M, Oksuz L, Basaran P “Decontamination of grains and legumes infected with Aspergillus spp. and Penicillum spp. by cold plasma treatment” Bioresource Technology 2008, 99, 5104-5109 that disclose no improvement (and perhaps worsening) in germination and rehydration as a result of plasma treatment. Without wishing to be held to any one theory, it is currently believed that plasma treatment in accordance with the teachings of Selcuk does not substantially reduce the apparent contact angle of the surface of a seed coat.

### Duration

The seed is exposed to a plasma for any suitable duration. In some embodiments, the seed is exposed to a plasma for not less than about 1 second. In some embodiments, the seed is exposed to a plasma for not more than about 60 minutes, not more than about 15 minutes and even not more than about 5 minutes. All things being equal, it is currently believed that shorter duration exposure allows saving in energy used to generate the plasma and allows greater throughput of the treatment. That said, it is also believed that exposure of plant seeds to a plasma for an excessive period of time (e.g., in some embodiments longer than 5 minutes) may cause damage or yield suboptimal results. Accordingly, in some embodiments a seed is exposed to a plasma for a short time, e.g., less than 5 minutes, not more than about 4 minutes, not more than about 2 minutes, not more than about 1 minute, not more than about 30 seconds, less than 30 seconds and even not more than about 20 seconds.

### Type of Plasma

In some embodiments, the plasma to which the seed is exposed is cold plasma, for example inductively coupled plasma, for example generated using a radiofrequency current, that is to say, the plasma is a cold radiofrequency glow discharge plasma (also called herein, radiofrequency plasma, using a radiofrequency glow discharge plasma source). In such embodiments, any suitable radiofrequency field having any suitable frequency is used to generate the plasma. In some embodiments, the plasma is generated by a radiofrequency field having a frequency of not less than about 100 KHz, not less than about 250 kHz, not less than about 500 kHz, not less than about 1 MHz, not less than about 3 MHz and even not less than about 5 MHz. In some embodiments, the plasma is generated by a radiofrequency field having a frequency of not more than about 100 MHz. In some embodiments, the plasma is generated by a radiofrequency field having a frequency of not more than about 80 MHz, not more than about 50 MHz, not more than about 20 MHz, and even not more than about 15 MHz. In some embodiments, the plasma is generated by a radiofrequency field having a frequency of between about 1 MHz and about 15 MHz, and even between about 5 MHz and about 14 MHz., for example about 10 MHz or about 13.56 MHz

In some embodiments, other suitable methods and plasma-generating devices are used to generate the cold plasma. In some embodiments, the method of generating the plasma is selected from the group consisting of electron cyclotron resonance (using an electron cyclotron resonance plasma source); corona discharge plasma (using a corona discharge plasma source), atmospheric arc plasma (using an atmospheric arc plasma source, “plasma spray torch”), vacuum arc plasma (using a vacuum arc plasma source), laser-generated plasma (using a laser plasma source). Details of various plasma sources are known in the art (see for example, Chu P K, Chen J Y, Wang L P, Huang N “Plasma-surface modification of biomaterials” Mat Sci and Eng 2002, R36, 143-206, which is included by reference as if fully set forth herein)

### Atmosphere

In some embodiments, the seed is exposed to a plasma generated by radiofrequency glow discharge plasma in a chamber including an atmosphere of gas from which the plasma is generated.

In such embodiments, the pressure of the atmosphere in the chamber (as measured just prior to generation of the plasma) is any suitable pressure. Radiofrequency glow discharge plasma is typically divided into low-pressure (between about 0.133 Pa (10⁻³ Torr) and 133 Pa (1 Torr)) and medium-pressure (between 133 Pa and 13300 Pa (100 Torr), where the electron density in the generated plasma increases with higher pressure.

In some embodiments, the pressure in the chamber is not more than about 500 Pa and even not more than about 250 Pa. In some embodiments, the pressure in the chamber is low-pressure, that is to say not more than about 133 Pa. In some embodiments, and not more than about 100 Pa, not more than about 50 Pa and even not more than about 20 Pa.

In some embodiments it has been found that superior results are achieved at very low pressures, that is to say not more than about 10 Pa, not more about than about 8 Pa, not more than about 5 Pa and even not more about than 2 Pa. Although not wishing to be held to any one theory, it is believed that in some embodiments, the electron density of the plasma at such very low pressures results in superior results.

In some embodiments, the atmosphere comprises a gas selected from the group of gases consisting of air, oxygen, nitrogen, argon and neon and mixtures thereof. In some embodiments, the atmosphere consists essentially of a gas selected from the group of gases consisting of air, oxygen, nitrogen, argon and neon and mixtures thereof. In some embodiments, the atmosphere consists of a gas selected from the group of gases consisting of air, oxygen, nitrogen, argon and neon and mixtures thereof.

In some embodiments, the atmosphere is substantially air. In some embodiments, the atmosphere is air.

In some embodiments, the atmosphere comprises oxygen (O₂). In some embodiments, the molar percent of oxygen in the atmosphere is not less than about 0.1%, not less than about 1%, not less than about 5%, not less than about 10% and even not less than about 20% oxygen.

In some embodiments, the atmosphere comprises nitrogen (N₂). In some embodiments, the molar percent of nitrogen in the atmosphere is not less than about 0.1%, not less than about 1%, not less than about 5%, not less than about 10% and even not less than about 20% nitrogen.

In some embodiments, the atmosphere comprises oxygen together with an inert gas (e.g., N₂, Ne, Ar, He or mixtures thereof). In some embodiments, the molar percent of the oxygen and the inert gas together comprises not less than about 5%, not less than about 10%, not less than about 20%, not less than about 40%, not less than about 60%, not less than about 80%, and even not less than about 95% of the atmosphere.

In some embodiments, the atmosphere comprises an inert gas (e.g., N₂, Ne, Ar, He and mixtures thereof) and includes less than 0.1% molar percent) of oxygen.

In some embodiments, the weight percent of organic carbon (weight percent of carbon in hydrocarbon molecules making up the atmosphere) in the atmosphere is not more than about 70%, not more than about 50%, not more than about 25%, not more than about 15%, not more than about 10%, not more than about 5%, not more than about 4% and even not more than about 2%. In some embodiments, the atmosphere includes not more than about 1% and even not more than about 0.1% molar percent of hydrocarbons.

In some embodiments, the atmosphere is substantially not flammable. In some embodiments, the atmosphere is substantially devoid of a flammable component such as hydrazine or cyclohexane.

In some embodiments, the atmosphere is substantially devoid of a toxic component such as hydrazine or aniline.

Plant Seeds Treated with Plasma

According to an aspect of some embodiments of the invention, there is also provided an ungerminated viable plant seed, exposed to plasma as described above.

According to an aspect of some embodiments of the invention, there is also provided a viable plant seed of a type of plant, comprising a seed coat, wherein the apparent contact angle of the (outer) surface of the seed coat is substantially lower (more hydrophilic) than the natural apparent contact angle of the surface of a seed coat of the type of plant, wherein the plant seed is an ungerminated viable plant seed.

In accordance with the teachings herein, the seed is devoid of an artificial coating comprising a substantial fluorine content produced by exposure to a plasma in a fluorine- containing atmosphere as disclosed in Volin et al, Crop. Sci. 2000, 40, 1706-1718, referenced above.

It is currently believed that some embodiments of the seeds according to the teachings herein are more susceptible than naturally occurring seeds of the same type to pathogens as a result of the reduced hydrophobicity of the seed coat surface. Accordingly, in some embodiments, the plant seeds are treated, before or after exposure to the plasma as described above, to neutralize pathogens such as fungus and fungal spores, bacteria and/or viruses, for example, by exposure to a chemical agent such as ethylene oxide or hydrogen peroxide (using the dry sterilization process).

In some embodiments, by substantially lower is meant that the apparent contact angle of the seed coat surface is not less than about 10°, not less than about 20°, not less than about 30° and even not less than about 40° lower than the natural apparent contact angle of a seed coat surface of the type of plant.

In some embodiments, the seed coat surface is hydrophilic, having an apparent contact angle of less than 90°. In some such embodiments, the plant seed is of a type of plant with a naturally hydrophobic seed coat surface having a natural apparent contact angle of greater than 90°. Accordingly, in some embodiments, the plant seed comprises a hydrophilic seed coat surface (apparent contact angle less than)90° that is ordinarily (naturally) hydrophobic (apparent contact angle greater than)90°.

The seeds are of any suitable type of plant, including vegetable seeds, grass seeds, oil seeds and grain seeds. That said, in some embodiments the seeds are of legumes (Fabaceae) such as alfalfa, carobs, chickpea (Cicer arietinum), clovers, fenugreek, lupins, mung beans, peas (Pisum sativum), soybeans (Glycine max) and vetches, but especially seeds of the genus Phaseolus, vigna and lentils (Lens culinaris). In some embodiments the seeds are Poaceae, such as Panicoideae such as maize, sorghum, sugarcane, millet; Ehrhartoideae such as rice; Avena such as oats; and Pooideae such as lawn grass, pasture grass and Triticeae, such as Hordeum (barley), Secale (rye) and especially Triticum (wheat, including kamut). Other suitable seeds include oil seeds (almond, hazelnut, linseed, peanut, sesame, sunflower), Brassica (arugula, broccoli, cabbage, daikon, mizuna, mustard, radish, tatsoi, turnip, watercress), umbelliferous vegetables (carrot, celery, fennel, parsley), allium (garlic, green onion, leek, onion), solanaceae (tomato, potato, paprika, aubergine or eggplant) and other edible plants such as amaranth, buckwheat, lettuce, maize, milk thistle, quinoa, rhubarb and spinach.

For example, in some embodiments, the seed is a lentil (Lens culinaris) seed having a seed coat surface with an apparent contact angle of not more than about 115°, not more than about 105°, not more than about 90°, not more than about 70°, not more than about 50° and even not more than about 30°. The natural apparent contact angle of a lentil seed coat surface is 127±2°.

For example, in some embodiments, the seed is a white bean (Phaseolus vulgaris) having a seed coat surface with an apparent contact angle of not than about 90°, not more than about 80°, not more than about 70°, not more than about 60° and even not more than about 55°. The natural apparent contact angle of a white bean seed coat surface is98±2°

For example, in some embodiments, the seed is a wheat (Triticum spp.) seed having a seed coat surface with an apparent contact angle of not more than about 95°, not more than about 90°, not more than about 80°, not more than about 60°, not more than about 40° and even not more than about 20°. The natural apparent contact angle of a wheat seed coat surface is 115±2°.

Uses of Plant Seeds Treated with Plasma

As noted above, some embodiments of the plasma treatment of seeds in accordance with the teachings herein have a number of unexpected advantages, in some embodiments one or more of increased germination rate, quicker onset of germination, shorter time window of germination, reduction of the amount of water required to germinate seeds, reduction of the amount of water required to rehydrate seeds, and/or reduction of the amount of time required to rehydrate seeds. Typically, subsequent to exposure to plasma in accordance with the teachings herein, a treated seed is germinated or rehydrated for further use.

Thus, in some embodiments, the method according to the teachings herein further comprises: contacting the seed with water (a term synonymous with the term “exposing the seeds to water” as used in U.S. 61/636,752). In some embodiments, the method further comprises: contacting the seed with water under conditions allowing the seed to germinate.

In some embodiments, the method further comprises: subsequent to the exposure to plasma, planting the seed, that is to say contacting with a medium and water allowing the seed to germinate and develop into a shoot, a seedling, and optionally a mature plant. In some such embodiments, the medium is a geoponics medium (e.g., soil in a field, green house, nursery). In some such embodiments, the medium is a hydroponics or aeroponics medium. Such embodiments are useful, inter alia, in the field of agriculture, for example for producing seedlings, shoots and/or small plants for consumption, sale and replanting, or for growing plants for harvest (e.g., of the plant, fruit or seeds) or other use (e.g., pasture). Such embodiments are useful for producing sprouts for consumption, e.g., by humans or animals, such as of pulses (alfalfa, clover, fenugreek, lentil, pea, chickpea, mung bean, soybean), cereals (oat, wheat, maize, rice, barley, rye, kamut), Cereal-like (quinoa, amaranth, buckwheat), oilseeds (almond, hazelnut, linseed, peanut, sesame, sunflower), Brassica (arugula, broccoli, cabbage, daikon, mizuna, mustard, radish, tatsoi, turnip, watercress), umbelliferous vegetables (carrot, celery, fennel, parsley), allium (garlic, green onion, leek, onion) and other edible plants such as spinach, lettuce and milk thistle.

In some embodiments, the method further comprises: subsequent to the exposure to plasma, waiting a period of time during which the plant seed sprouts, and subsequently preparing a foodstuff from the sprouted seeds. Such embodiments are typically applied to preparation of foodstuffs that require the use of germinated seeds such as malted grain especially barley (e.g., for preparing beer, whiskey, malted vinegar, confections, malted beverages, malt extract and barley malt), wheatgrass and breads such as Essene bread and malt loaf.

In some embodiments, the method further comprises: subsequent to the exposure to plasma, contacting the plant seed with water for rehydration of the seed (e.g., by soaking), and subsequently preparing a foodstuff from the rehydrated seed. Such embodiments are typically applied to seeds that are stored dry and must be rehydrated for use (typically legumes such as lentils, beans and chickpeas) in the preparation of foodstuffs such as soups, stews and spreads (e.g., hummus).

### Devices According to the Teachings Herein

The teachings herein may be implemented using any suitable plasma-generating device (as described above) suitable for exposing plant seeds to plasma under suitable conditions as described herein. Typically, such plasma-generating devices are instruments configured for scientific research, operable by or under the supervision of highly-skilled scientific personnel, and allowing various operation parameters to be changed and adjusted.

In some embodiments, the teachings herein are implemented using a plasma-generating device specifically configured for implementing the teachings herein. Such embodiments are typically configured for simple operation, even by an unskilled operator or where even a skilled operator is preferably not preoccupied with device settings.

In some such embodiments, the device is configured for switch operation: a user activates a control (e.g., a single button, a plurality of buttons) that leads to generation of plasma from the required type of atmosphere at the required pressure at the required radiofrequency for the required duration, without needing to set any of the parameters.

Thus, according to an aspect of some embodiments of the teachings herein, there is provided a device for the treatment of seeds, comprising a plasma-generator suitable for exposing plant seeds to generated plasma; and an operator-interface, allowing an operator to activate the plasma-generator to implement the method according to teachings herein. In some embodiments, the device is configured to be limited to generating plasma only within the parameters suitable for implementing the teachings herein.

In some embodiments, the device is configured for continuous operation, that is to say, the device is configured, when activated, to substantially constantly generate plasma, to continuously feed untreated seeds to be exposed to the plasma, and to continuously extract seeds already treated by exposure to the plasma in accordance with the teachings herein. In some embodiments, the device is configured for batchwise treatment of seeds.

### Duration

In the art, plasma-generating devices typically include an activate/deactivate switch. An operator activates the device through the switch to generate plasma, and consults a timepiece until sufficient time of plasma generation is achieved, and then deactivates the device using the switch.

In some embodiments, the device is configured so that the duration that seeds being treated by the device are exposed is limited to a duration in accordance with the teachings herein. Implementation of such limitations of duration is well within the ability of a person having ordinary skill in the art of electronics and device control upon perusal of the teachings herein, and typically includes the use of a software or hardware timer.

For example, in some embodiments, the maximal duration of exposure is limited to a predetermined maximal duration according to the teachings herein. Activation of the device through the operator-interface leads to plasma generation no longer than the predetermined maximal duration. In some such embodiments, the predetermined maximal duration is less than 5 minutes, not more than about 4 minutes, not more than about 2 minutes, not more than about 1 minute, not more than about 30 seconds, less than 30 seconds and even not more than about 20 seconds.

For example, in some such embodiments, the duration of exposure is fixed to a single predetermined value according to the teachings herein. Each activation of the device through the operator-interface causes the device to generate plasma only for the fixed single value. In some such embodiments, the single predetermined duration is less than 5 minutes, not more than about 4 minutes, not more than about 2 minutes, not more than about 1 minute, not more than about 30 seconds, less than 30 seconds and even not more than about 20 seconds.

For example, in some embodiments, the duration of exposure is limited to a relatively small number of predetermined values, for example labelled in accordance to seed type to be treated. In some such embodiments, the predetermined values of duration are all less than 5 minutes, not more than about 4 minutes, not more than about 2 minutes, not more than about 1 minute, not more than about 30 seconds, less than 30 seconds and even not more than about 20 seconds.

### Locations Including a Plasma-Generating Device

Known plasma-generating devices are useful in the field of scientific research and heavy industry and are typically found in scientific laboratories and factories. The teachings herein provide for utility of processing plant seeds for food and agriculture, teaching the utility of placing a plasma-generating device in locations where plant seeds are used for food and agriculture.

In some instances, the teachings herein are implemented in a central location, for example, a seed factory for the treatment and manufacture of seeds in accordance with the teachings herein. The treated seeds are then transported to a location for use. In some embodiments, subsequent to treatment, the treated seeds are placed in a protected environment (e.g., sealed in an inert atmosphere, preferably without water, in some embodiments subsequent to pathogen-neurtalization treatment) to avoid premature germination and/or pathogen development.

In some embodiments, it is preferred to implement the teachings herein as close as possible (spatially and/or temporally) to where the treated seeds will be germinated. For instance, the teachings herein are advantageously implemented in a kitchen (home, restaurant, cafeteria, catering establishment), for instance for preparing foodstuffs from hydrated seeds (e.g., bean, lentil, chickpeas for soup, stews and spreads like hummus) or sprouts for consumption. Thus, according to an aspect of some embodiments of the teachings herein, there is provided a kitchen comprising a plasma-generating device, the device suitable for treating plant seeds in accordance with embodiments of the method according to the teachings herein. In some embodiments, the plasma-generating device is limited to generating plasma suitable for implementing the teachings herein and is so configured so as not to be functional for generating plasma not suitable for implementing the teachings herein. In some embodiments, the plasma-generating device is configured as a kitchen appliance, suitable for treating seeds in accordance with the teachings herein.

For instance, the teachings herein are advantageously implemented in an industrial food-manufacturing location (e.g., a brewery, a distillery, a bakery, a food-processing plant), for instance for preparing foodstuffs from hydrated seeds (e.g., bean, lentil, chickpeas for soup, stews and spreads like hummus), sprouts for consumption, breads, and drinks such as beer and whiskey. Thus, according to an aspect of some embodiments of the teachings herein, there is provided a food-manufacturing location comprising a plasma-generating device, the device suitable for treating plant seeds in accordance with embodiments of the method according to the teachings herein. In some embodiments, the plasma-generating device is limited to generating plasma suitable for implementing the teachings herein and is so configured so as not to be functional for generating plasma not suitable for implementing the teachings herein.

For instance, the teachings herein are advantageously implemented in a plant-growing location (e.g., a farm, a greenhouse, a plant nursery, a hydroponics farm, an aeroponics farm, a vertical farm), especially an industrial plant-growing location, for instance for treating plant seeds in accordance with the teachings herein, for example prior to planting or prior to being feed to animals such as livestock. Thus, according to an aspect of some embodiments of the teachings herein, there is provided a plant-growing location comprising a plasma-generating device, the device suitable for treating plant seeds in accordance with embodiments of the method according to the teachings herein. In some embodiments, the plasma-generating device is limited to generating plasma suitable for implementing the teachings herein and is so configured so as not to be functional for generating plasma not suitable for implementing the teachings herein.

### Agricultural Device

In some embodiments in the field of agriculture, it is desirable to plant seeds as soon as possible after treatment in accordance with the teachings herein. Thus, according to an aspect of some embodiments of the teachings herein, there is provided an agricultural device comprising: a plasma-generating component suitable for treating plant seeds in accordance with embodiments of the method according to the teachings herein; and functionally associated with the plasma-generating component, a sowing-component, configured to plant seeds accepted from the plasma-generating component subsequent to the treatment.

In some such embodiments, plant seeds are held in a seed reservoir of the agricultural device, in the usual way. When it is desired to plant the seeds, untreated seeds are feed from the seed reservoir to the plasma-generating component to be treated in accordance with the teachings herein, and subsequently are directed to the sowing-component for sowing in the usual way.

In some such embodiments, the plasma-generating component is an atmospheric- pressure plasma-generating component.

In some such embodiments, the device includes an airlock configured to transfer treated seeds from a location (e.g., chamber) where seeds are treated in accordance with the teachings herein at subatmospheric pressure to the sowing-component at atmospheric pressure.

In some embodiments, the device includes an airlock configured to transfer seeds from a seed reservoir at atmospheric pressure to a location (e.g., chamber) where seeds are treated in accordance with the teachings herein at subatmospheric pressure. In some embodiments, the seed reservoir is maintained at a subatmospheric pressure during operation of the device, typically so no airlock is required. In some embodiments, the seed reservoir is configured to be operable as a location (e.g., chamber) where seeds are treated in accordance with the teachings herein at subatmospheric pressure.

In some embodiments, the plasma-generating component of the agricultural device is limited to generating plasma suitable for implementing the teachings herein and is so configured so as not to be functional for generating plasma not suitable for implementing the teachings herein. In some embodiments, the sowing-component is selected from the group consisting of a planter (e.g., a variant of or based on a DB120 or model 1700 series), an air seeder (e.g., a variant of or based on model 740A/750A) and a seed drill (including grain drills, e.g., a variant of or based on model 1590), all by John Deere, Moline, Ill., USA. I

### Experimental

### Seeds

Seeds of lentil (Lens culinaris), white beans (Phaseolus vulgaris) and wheat (Triticum spp) for human consumption bearing organically-grown certification were acquired from a supermarket.

Untreated seeds

The surfaces of the seed coats of untreated seeds were examined using scanning electron microscope (JSM-651OLV by JEOL Ltd., Tokyo, Japan).

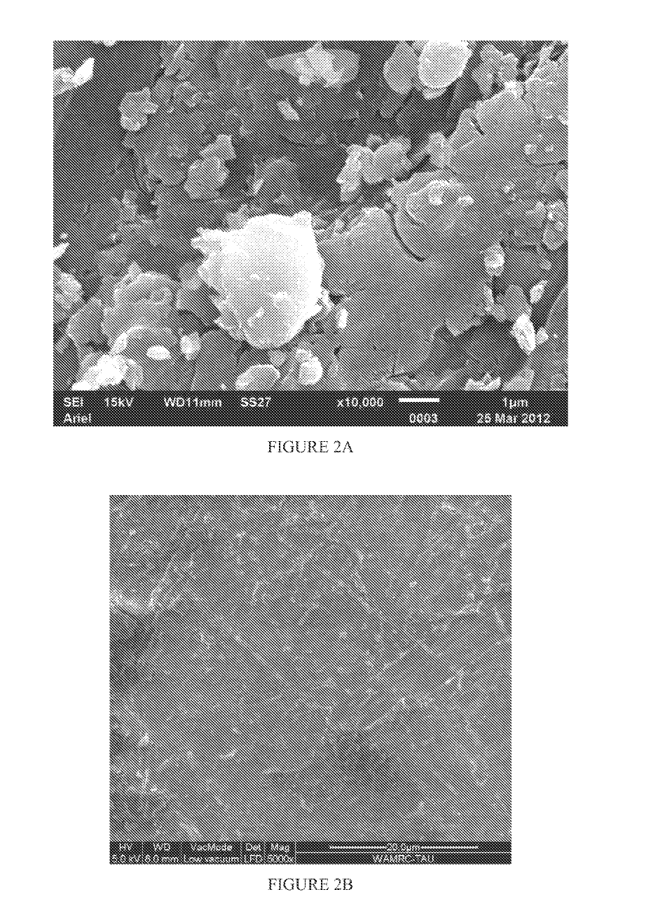

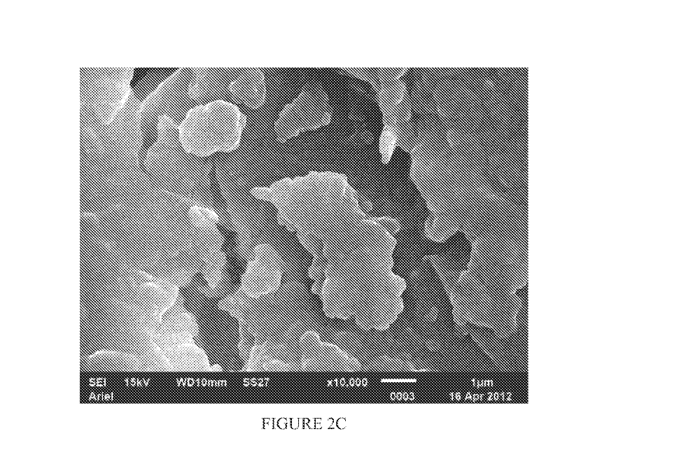

In FIG. 2A, a reproduction of a SEM image (10000×, scale bar is 1 micrometer) of an untreated lentil, is seen that an untreated lentil seed coat surface is rough, comprising granules (presumably protein granules) having sizes ranges from about 0.2 to 30 micrometers.

In FIG. 2B, a reproduction of a SEM image (5000×, scale bar is 20 micrometer) of an untreated bean, is seen that an untreated bean seed coat surface is smooth.

In FIG. 2C, a reproduction of a SEM image (10000×, scale bar is 1 micrometer) of an untreated wheat seed, is seen that an untreated wheat seed coat surface is rough, like a lentil seed coat surface.

Droplets of water were placed on the surface of untreated seed coats and the apparent contact angle of the untreated seeds was measured in the usual way using a Ramé-Hart goniometer (model 500), and 10 separate measurements were taken to calculate the mean apparent contact angles for both kinds of seeds. The untreated seeds were found to be hydrophobic.

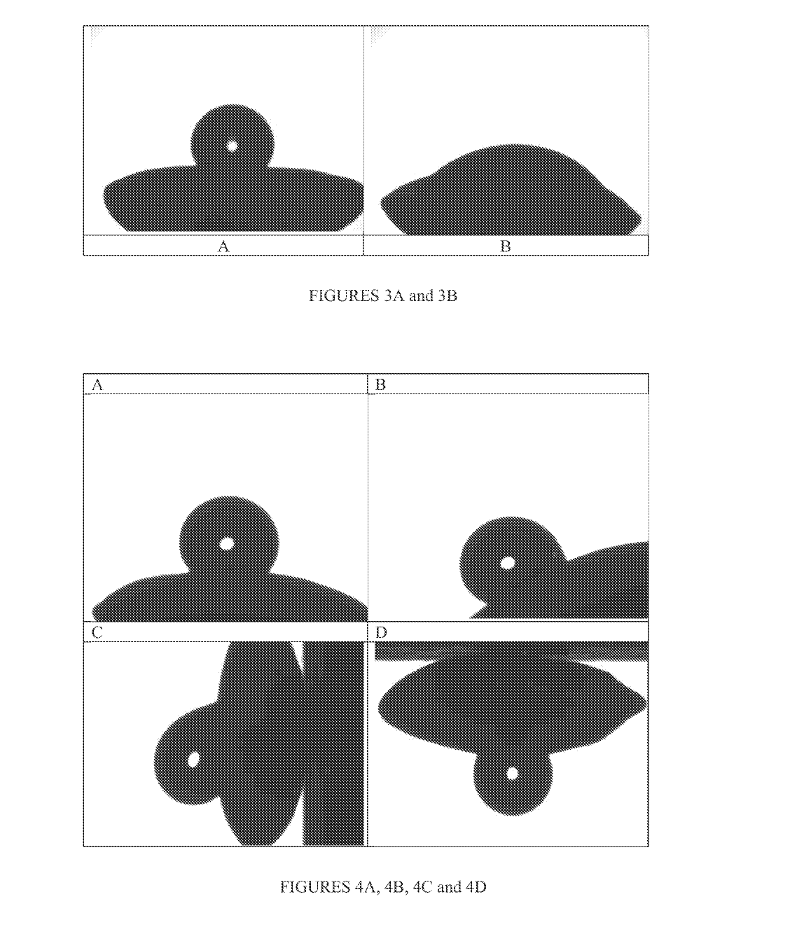

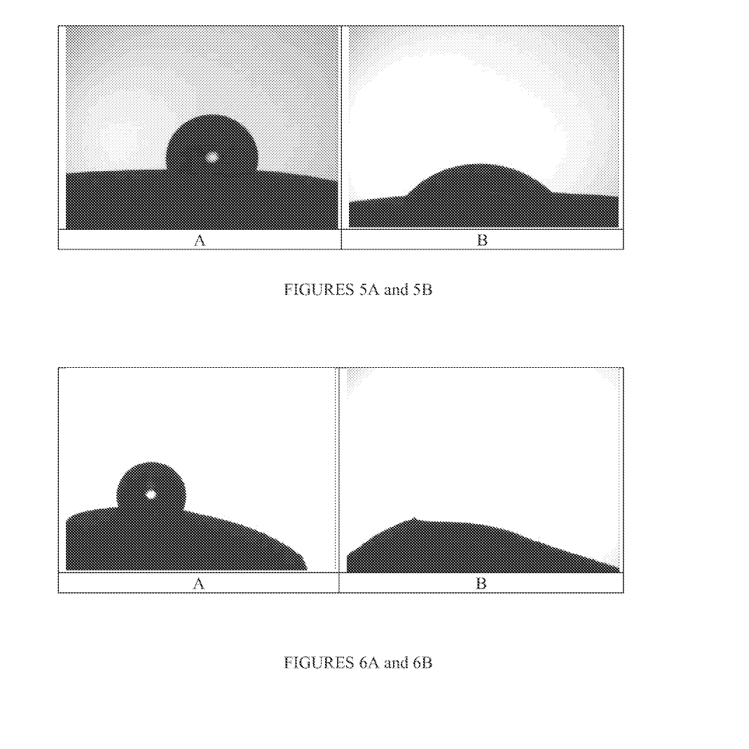

The apparent contact angle of the untreated lentil seed coat surface was determined to be 127±2°. In FIG. 3A is a reproduction of a photograph showing a droplet of water on the surface of an untreated lentil. Interestingly, the high apparent contact angle observed for the untreated lentil seeds is accompanied by high contact angle hysteresis as seen in FIGS. 4A, 4B, 4C and 4D. A hydrophobic state that is simultaneously sticky (adhesive) is characteristic of the so-called “rose-petal effect”.

The apparent contact angle of the seed coat surface of untreated beans was determined to be 98±2°. In FIG. 5A is a reproduction of a photograph showing a droplet of water on the surface of an untreated bean.

The apparent contact angle of the untreated wheat seed coats was determined to be 115±2°. In FIG. 6A is a reproduction of a photograph showing a droplet of water on the surface of an untreated wheat seed. Like the untreated lentil seeds, in untreated wheat seeds the high apparent contact angle observed is accompanied by high contact angle hysteresis that is simultaneously sticky (adhesive).

### Plasma Treatment

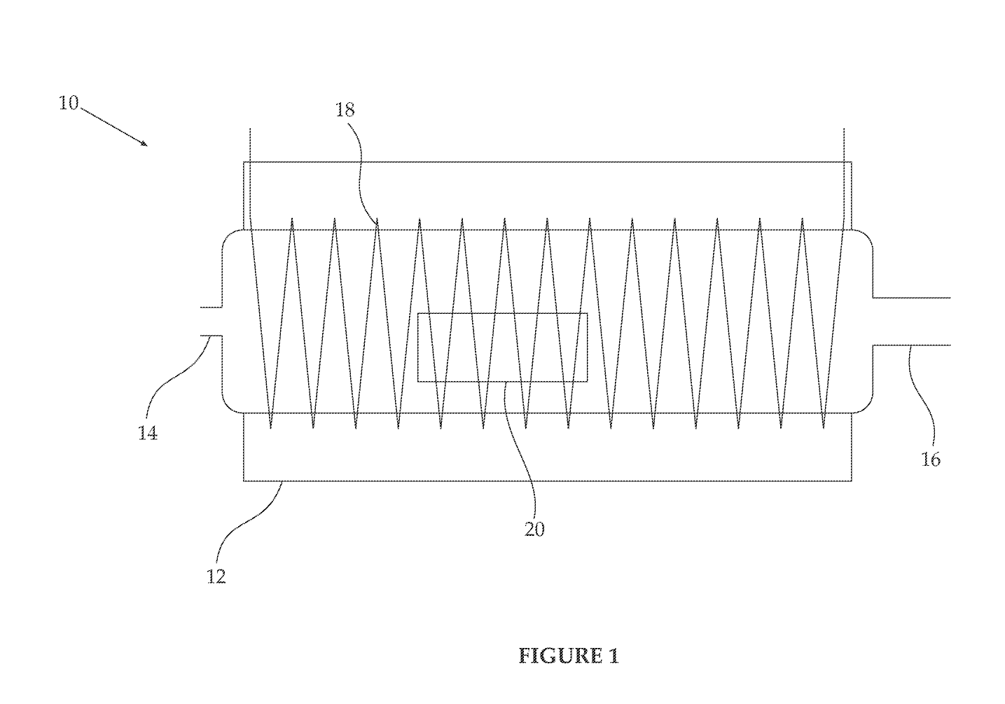

A cylindrical inductively-coupled plasma device (PDC-32G by Harrick Plasma, Ithaca. N.Y., USA) is schematically depicted in FIG. 1 as device 10.

Device 10 has a 7.62 cm (3″) diameter by 16.51 cm (6.5″) long cylindrical Pyrex chamber 12, a gas inlet port 14 (⅛″ NPT needle valve to qualitatively control gas flow and chamber pressure), a three-way port 16 (⅛″ NPT 3-way valve to quickly switch from bleeding in gas, isolating the chamber, and pumping) and a helical electrode 18. A vacuum pump (PDC-OPD-2 by Harrick Plasma, Ithaca, N.Y., USA, not depicted) was functionally associated with device 10 through port 16 to allow evacuation of the gaseous content of chamber 12.

A 50 g sample of untreated seeds 20 was placed in chamber 12.

Chamber 12 was evacuated using the vacuum pump and then and filled with an atmosphere of ambient air to a final pressure of 1 Pa (10⁻⁵ bar).

The radiofrequency power source of the device was activated to generate a 18 W 10 MHz radiofrequency current for 15 seconds, ionizing components of the gas in chamber 12 to generate plasma therein.

Seeds Treated in Accordance with an Embodiment of the Teachings Herein

The seed coat surfaces of the treated seeds were examined using a scanning electron microscope as described above. No difference was apparent between the treated seeds and the respective untreated seeds depicted in FIGS. 2A, 2B and 2C.

Droplets of water were placed on the seed coat surface of treated seeds and the apparent contact angle of the treated seeds was described above. The treated seeds were found to be hydrophilic.

The apparent contact angle of the seed coat surface of treated lentils was determined to be 20±1°. In FIG. 3B is a reproduction of a photograph showing a droplet of water on the surface of the seed coat of a treated lentil.

The apparent contact angle of the seed coat surface of treated beans was determined to be 53±2°. In FIG. 5B is a reproduction of a photograph showing a droplet of water on the surface of the seed coat of a treated bean.

The apparent contact angle of the seed coat surface of treated wheat seeds was determined to be 0°. In FIG. 6B is a reproduction of a photograph showing a droplet of water on the surface of the seed coat of a treated wheat seed. Untreated seeds of all three types were placed in chamber 12 of the plasma treatment device 10. Chamber 12 was evacuated, filled with ambient air at 1 Pa (10⁵ bar) and the seeds held in the low pressure without exposure to plasma for a time equivalent to the time that the treated seeds were held in chamber 12. The apparent contact angle of the seed coat surfaces was measured and found to be identical to that previously determined for the untreated seeds.

### No Hydrophobic Recovery

Treated seeds were stored in a closed jar (glass jar with metal screw lid). After a week of storage, the apparent contact angle of the seed coat surfaces was measured again and found to be identical to the above. No hydrophobic recovery was observed.

### Water Absorption

To study the effect of the treatment in accordance with the teachings herein on water absorption, 48 seeds each of untreated lentils, treated lentils, untreated beans, treated beans, untreated wheat seeds and treated wheat seeds were maintained in moistened cotton batting at ambient conditions. Using an MRC ASB-220-C2 analytical balance, the beans were weighed every twenty-four hours (over a period of five days) while the lentils and wheat seeds were weighed every thirty minutes (over a period of 7 hours).

The relative water absorption was defined as:

$$\frac{Δ m ( t )}{{m}_{0}} 100 \% = \frac{m ( t ) - {m}_{0}}{{m}_{0}} 100 \%$$

where m₀ was the total initial mass of 48 seeds of one type, and m(t) was the total mass of seeds at time t.

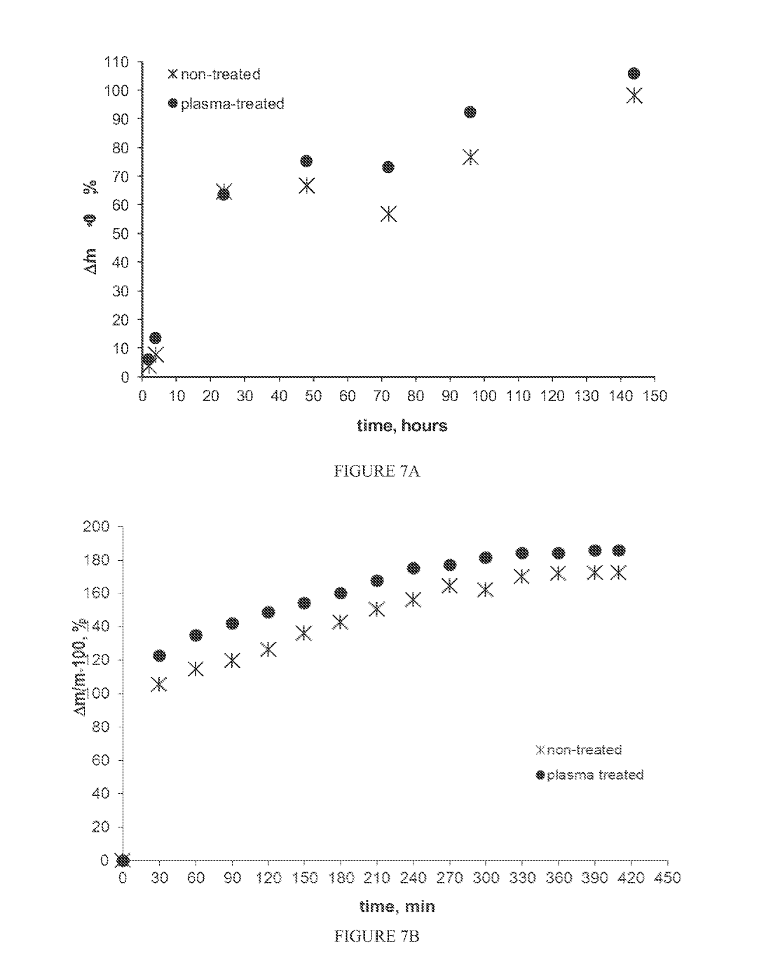

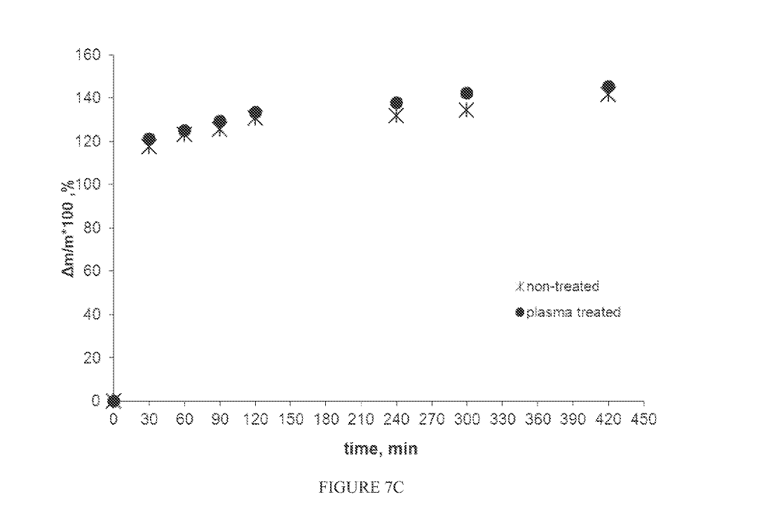

Results are shown in the graphs depicted in FIG. 7A (treated and untreated beans over 5 days), in FIG. 7B (treated and untreated lentils over seven hours) and in FIG. 7C (treated and untreated wheat seeds over seven hours), showing the time-dependence of the average water absorption normalized by the initial mass of seeds.

From FIG. 7A it is seen that over the period of 5 days, treated beans absorb more water than do untreated beans.

From FIG. 7B it is seen that over the period of 7 hours, treated lentils absorb more water than do untreated lentils.

From FIG. 7C it is seen that over the period of 7 hours, treated wheat seeds absorb more water than do untreated lentils.

### Germination

To study the effect of the treatment in accordance with the teachings herein on germination, 48 seeds each of untreated lentils, treated lentils, untreated beans, treated beans, untreated wheat seeds and treated wheat seeds were maintained in moistened cotton batting at ambient conditions, each seed in an own cell in a germination tray. The seeds were observed. Germination was considered to occur when a distinct sprout was seen.

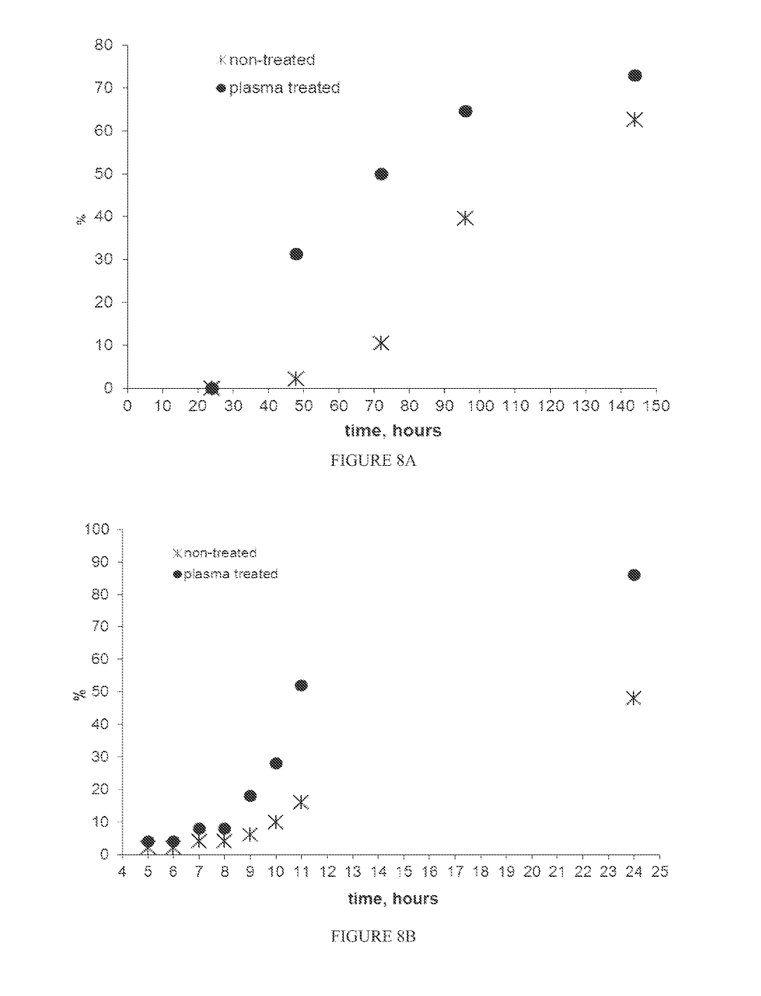

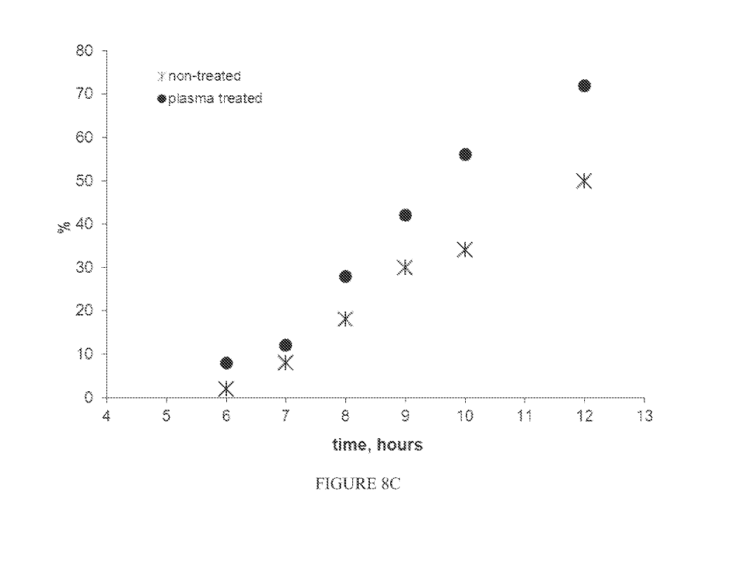

Results are shown in the graphs depicted in FIG. 8A (treated and untreated beans over 6 days), in FIG. 8B (treated and untreated lentils over a day) and in FIG. 8C (treated and untreated wheat seeds over 12 hours)

From FIGS. 8 it is seen that for all three seed-types, treatment in accordance with the teachings herein provided a marked acceleration of germination and an increase in germination rate.

### Mechanism

Although not wishing to be bound to any one theory, the Inventors hypothesize that treatment of seeds in accordance with some embodiments of the teachings herein increase the oxygen content on the seed surface, thereby increasing hydrophilicity thereof.

Although not wishing to be bound to any one theory, the Inventors hypothesize that treatment of seeds in accordance with some embodiments of the teachings herein increases the nitrogen content on the seed surface, thereby increasing available nutrients for the sprout that increases germination rate.

Although not wishing to be bound to any one theory, the Inventors hypothesize that treatment of seeds in accordance with some embodiments of the teachings herein etches the seed surface in a way that reduces the apparent contact angle of the seed surface, reducing the hydrophobicity of the seed surface.

### Pressure of Plasma Treatment

The above experiment is repeated where the pressure in the chamber during plasma treatment is 0.8 Pa, 2, 3, 5 and 7.5 Pa. The seeds treated at the various pressures are found to have substantially the same properties as the treated seeds described above.

### Duration of Plasma Treatment

The above experiments are repeated where the power source generating the radiofrequency field is activated for 30 seconds, 1 minute, 2 minutes and 4 minutes. The seeds treated for 30 seconds and longer are found to have substantially the same properties as the seeds treated for 15 seconds as described above.

### Different Plasmas

The above experiments were repeated for lentil, bean and wheat seeds where the atmosphere in the plasma chamber during treatment is substantially pure nitrogen gas (N₂) or substantially pure oxygen gas (O₂). The seeds treated with such atmospheres were found to have substantially the same properties as the seeds treated with air plasma as described above.

The above experiments are repeated where the atmosphere in the plasma chamber during treatment is neon, argon, helium or mixtures thereof and, depending on the embodiments, including a molar percent of oxygen of not less than 0.1%, not less than 1%, not less than 5%, not less than 10% and even not less than 20% oxygen. The seeds treated with such atmospheres are found to have substantially the same properties as the seeds treated with air plasma as described above.

Sarcopoterium spinosum

Sarcopoterium spinosum, also known as thorny burnet and Poterium spinosum, is an abundant and characteristic species of the Eastern Mediterranean. S. spinosum is a chamaephyte of the Rosacea family. The natural germination rate of S. spinosum seeds is extremely low.

Seeds of naturally-occuring S. spinosum were gathered from fields bordering an urban area in Samaria from a large number of plants.

The gathered seeds were divided into five groups:

a) seeds of group I and V were not treated with plasma;

b) seeds of group II were placed in the plasma-generating device described above, and treated with plasma generated with an 18 W 10 MHz radiofrequency field in an atmosphere of air at a pressure of 1 Pa for 1 minute; and

c) seeds of group III and IV were placed in the plasma-generating device described above, and treated with plasma generated with an 18 W 10 MHz radiofrequency field in an atmosphere of air at a pressure of 1 Pa for 2 minutes.

Each one of the five groups was divided into four batches of 117 seeds, and each one of the 20 batches was sown in a separate delineated area of soil on 30 Nov. 2012 in an open area in Samaria protected from grazing animals.

The soil in which batches of groups I, II and III were sown was manually watered immediately after sowing. The soil in which batches of groups IV and V were sown was not watered.

The number of S. spinosum plants that sprouted was counted on 1 Dec. 2013, 1 month subsequent to sowing. The results are presented in Table 1.

TABLE 1

| | | average | | germination rate |
|---|---|---|---|---|
| | | sprouts for | standard | (average of four |
| Group | treatment | four batches | deviation | batches) |
| I | no plasma | 7.5 | 1.1 | 6.4% |
| | water | | | |
| II | 1 min plasma | 7.5 | 3.16 | 6.4% |
| | water | | | |
| III | 2 min plasma | 9 | 1.56 | 7.7% |
| | water | | | |
| IV | 2 min plasma | 11.5 | 2.04 | 9.8% |
| | no water | | | |
| V | no plasma | 8 | 1.85 | 6.8% |
| | no water | | | |

It is seen that plasma treatment in accordance with the teachings herein increases the germination rate of seeds of S. spinosum.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

1. A method of treating plant seeds comprising:
providing a plant seed having a seed coat with an outer surface having a natural apparent contact angle; and
exposing said plant seed to a plasma under conditions effective to substantially reduce the apparent contact angle of said seed coat surface from said natural apparent contact angle to a treated apparent contact angle.

2. The method of claim 1, wherein said apparent contact angle is reduced by not less than about 10°.

3. The method of claim 1, wherein said exposing of said plant seed to said plasma is such that said treated apparent contact angle is less than 90°.

4. The method of claim 3, wherein said natural apparent contact angle is greater than 90°.

5. The method of claim 1, wherein said plasma comprises a cold radio-frequency plasma.

6-9. (canceled)

10. The method of claim 1, wherein said seed is exposed to said plasma for not more than about 60 minutes.

11. The method of claim 1, wherein said seed is exposed to said plasma for not more than about 4 minutes.

12. The method of claim 1, wherein said seed is exposed to said plasma for not more than about 1 minute.

13. The method of claim 1, wherein said seed is exposed to said plasma in a chamber including an atmosphere from which said plasma is generated.

14-17. (canceled)

18. The method of claim 1, further comprising: subsequent to said exposure to plasma, contacting said seed with water.

19. The method of claim 18, wherein said contacting with water is under conditions allowing said seed to germinate.

20. The method of claim 19, further comprising: planting said seed.

21. The method claim 18, further comprising: subsequent to said exposure to plasma, waiting a period of time during which said plant seed sprouts; and subsequently preparing a foodstuff from said sprouted seed.

22. The method of claim 18, further comprising: subsequent to said exposure to plasma, contacting said plant seed with water for rehydration of said seed; and subsequently preparing a foodstuff from said rehydrated seed.

23. A location comprising:
a plasma-generating device,
said plasma-generating device configured for treating plant seeds according to claim 1; and the location selected from the group consisting of a kitchen, a food-manufacturing location and a plant-growing location.

24. An agricultural device comprising:
a plasma-generating component suitable for exposing plant seeds to a plasma under conditions effective to substantially reduce the apparent contact angle of a seed coat surface of said plant seeds from said natural apparent contact angle to a treated apparent contact angle; and
functionally associated with said plasma-generating component, a sowing-component, configured to plant seeds accepted from said plasma-generating device subsequent to said exposure to said plasma.

25. A viable plant seed of a type of plant, comprising a seed coat, wherein the apparent contact angle of the surface of said seed coat is substantially lower than that of the natural apparent contact angle of the surface of a seed coat of the type of plant wherein the plant seed is an ungerminated viable plant seed.

26. The plant seed of claim 25, wherein said apparent contact angle of the surface of said seed coat is not less than about 10° lower than the natural apparent contact angle of a surface of a seed coat of the type of plant.

27. The plant seed of claim 25, wherein the surface of said seed coat is hydrophilic, having an apparent contact angle of less than 90°.

28. The plant seed of claim 27, wherein the plant seed is of a type of plant with a naturally hydrophobic seed coat surface having a natural apparent contact angle of greater than 90°.
